(19) United States
(12) Patent Application Publication
(10) Pub. No.: US 2011/0161711 A1
(43) Pub. Date: Jun. 30, 2011

(54) Control Device, Control Method, and Recording Medium

(75) Inventor: Akio TAKAMOTO, Nagano-ken (JP)

(73) Assignee: SEIKO EPSON CORPORATION, Tokyo (JP)

(21) Appl. No.: 12/971,494

(22) Filed: Dec. 17, 2010

(30) Foreign Application Priority Data
Dec. 29, 2009 (JP) 2009-299057

(51) Int. Cl. G06F 1/32; G06F 9/54

(52) U.S. Cl. 713/324; 719/321

(57) ABSTRACT

Power consumption by an external device can be reduced while controlling the external device by a generic device driver even when the generic device driver does not have a power management function for the external device. When a command generated by operation of a POS application 21 or printer driver 22 functioning as a host program is a specific command, the host computer 1 connected to the printer 3 being controlled relays the command to the generic device driver 24. When the command is not the specific command, the host computer 1 sends a dummy response to the command to the host program, and if the specific command is not sent for a specified time or longer, a function of a power management module 26 causes the printer 3 to enter a power conservation state.

### CROSS-REFERENCE TO RELATED APPLICATION

This application claims priority under 35 U.S.C. §119 to Japanese Patent Application No. 2009-299057 filed on Dec. 29, 2009, the entire disclosure of which is expressly incorporated by reference herein.

### BACKGROUND

1. Technical Field

The present invention relates to a control device that is connected to an external device such as a recording device to be controlled, to a control method that is executed by the control device, and to a recording medium.

2. Related Art

A program such as a device driver for the recording device to be controlled is generally installed in a control device such as a computer that controls an external device such as a recording device, and the external device (recording device) is controlled using the functions provided in the device driver. See, for example, Japanese Unexamined Patent Appl. Pub. JP-A-2008-077228.

In addition to dedicated device drivers that are provided by the manufacturer of the recording device or other external device, generic device drivers that are included in the operating system of the computer or control device are also common. Such generic device drivers typically render control functions that are common to plural external devices.

Unlike a dedicated device driver, generic device drivers are designed to provide control common to a variety of external devices, and are not compatible with specialized control functions that are available to only some external devices. As a typical example, a dedicated device driver may render an energy-saving sleep function that moves the external device to a standby or sleep mode when the external device has not been used for a predetermined time in order to save energy, but this device function cannot be used if it is not supported by the generic device driver. If a separate program for using functions not supported by the generic device driver is used to control the external device while also using the generic device driver, this separate program may conflict with control asserted by the generic device driver.

### SUMMARY

A control device, control system, control method, and recording medium storing the control method according to the invention enable reducing the power consumption of an external device while using a generic device driver to control the external device even when, for example, the generic device driver does not have an energy management function for managing the external device.

A first aspect of the invention is a control device that can connect through an interface to an external device, including: a device driver that controls the external device based on a command generated by a program installed on the control device; a power management module that generates a command that causes the external device to enter a power conservation state; and a response control unit that relays communications between the program and the device driver, and selectively sends commands received from the program to the device driver; the response control unit determining if a command sent by the program is a specific command, and the power management module generating and sending through the interface to the external device a command to move the external device to the power conservation state when the response control unit does not receive the specific command for a specified time or longer.

Preferably, the command that causes the external device to enter the power conservation state is a command setting the external device to a sleep mode.

Further preferably, the device driver is a generic device driver that can control plural types of external devices.

Yet further preferably, the response control unit sends the command to the device driver when the command sent by the program is determined to be a specific command, and does not send the command to the device driver when the command is determined to be other than the specific command.

With this aspect of the invention, when a specific command related to the external device is sent by operation of the program to the response control unit, the response control unit sends this command to the generic device driver, and the generic device driver controls the operation and configuration of the external device. If the specific command is not sent for a specified time or longer, a function of the power management module causes the external device to enter a sleep mode or other power conservation state.

As a result, the external device can be operated without affecting operation of the program when controlling the external device only by the generic device driver is necessary, and the generic device driver and external device can be operated more efficiently without relying on a function of the generic device driver. In addition, the external device can be moved to a power conservation state to reduce power consumption and improve operating efficiency of the external device when the generic device driver and external device are not operated for a certain period of time. The generic device driver can therefore be used to control the external device, and power conservation and operating efficiency can be improved without relying on a function of the generic device driver.

In another aspect of the invention, the power management module sends to the external device a command telling the external device to enter a power conservation state as controlled by the response control unit.

Because the power management module sends a command for entering the power conservation state to the external device, the external device can easily switch to the power conservation state without relying on a function of the generic device driver if the external device is compatible with a command instructing it to enter a power conservation state.

In a control device according to another aspect of the invention, when the response control unit determines that the specified command was received after sending to the external device a command telling the external device to enter the power conservation state, the response control unit generates by the power management module a command causing the external device to resume normal operation from the power conservation state, and sends the command to the external device through the interface.

With this aspect of the invention, when a specific command is sent by operation of the program after the external device has entered the power conservation state, the response control unit causes the external device to resume the normal operating mode from the power conservation state and then execute the specific command. As a result, the external device can be set to a power conservation state, or the external device can be reset from the power conservation state to the normal operating mode without affecting operation of the program, and power conservation and operating efficiency can thus be improved.

Further preferably, the specified command includes a recording job instructing the external device to execute a recording operation, and commands other than the specified command include a command requesting a status report from the external device.

Yet further preferably, the response control unit generates and sends a dummy response in response to the command to the program when the command sent by the program is determined to request the status of the external device.

With these aspects of the invention, because the external device is operated by control of the generic device driver when a recording job instructing the external device to execute a recording operation is transmitted by the operation of the program, and the response control unit sends a dummy response and does not cause the external device to operate when the received command is not a recording job, such as when it is a command requesting the status of the external device, power conservation and operating efficiency can be improved without affecting program operation.

Another aspect of the invention is a control system including an external device and a control device connected to the external device through an external device connection interface. The control device includes a generic device driver that can control plural types of external devices connected through the interface based on commands sent by at least one of an application program and a control program that controls the external device; a power management module that can change a device connected through the interface to a power conservation state; and a response control unit that can relay commands sent by the program to the generic device driver. When the command sent by the program is a specific command, the response control unit relays the command to the generic device driver; when the command is other than the specific command, the response control unit does not relay the command to the generic device driver and returns a dummy response to the command to the program, and when the time for which the specific command is not sent continues for at least a specific time, causes the external device to enter the power conservation state by the power management module.

With this aspect of the invention, when a specific command is sent to the external device by the operation of a program executed by the control device, the response control unit sends the command to the generic device driver and the generic device driver controls the operation and configuration of the external device. When a command other than the specific command is sent, the response control unit instead of the generic device driver sends a dummy response to the program and the generic device driver does not operate. If the time for which the specific command is not sent continues for a specified time or longer, the power management module shifts the external device to a power conservation state.

As a result, the external device can be operated without affecting operation of the program when controlling the external device only by the generic device driver is necessary, and the generic device driver and external device can be operated more efficiently without relying on a function of the generic device driver. In addition, the external device can be moved to a power conservation state to reduce power consumption and improve operating efficiency of the external device when the generic device driver and external device are not operated for a certain period of time. The generic device driver can therefore be used to control the external device, and power conservation and operating efficiency can be improved without relying on a function of the generic device driver.

Another aspect of the invention is a control method for a control device that can connect through an interface to an external device, including steps of: receiving and determining if a command generated and sent by a program installed on the control device is a specific command; and if the time for which the response control unit does not receive the specific command is greater than or equal to a specified time, generating a command that causes the external device to enter a power conservation state, and sending the command through the interface to the external device.

Preferably, the command causing the external device to enter the power conservation state is a command setting the external device to a sleep mode.

Further preferably, the command is sent to the device driver when the command sent by the program is determined to be a specific command, and the command is not sent to the device driver when the command is determined to be other than the specific command.

In a control device control method according to another aspect of the invention, the device driver is a generic device driver that can control plural types of external devices.

In a control device control method according to another aspect of the invention, the specified command includes a recording job instructing the external device to execute a recording operation, and commands other than the specified command include a command requesting a status report from the external device.

The control device control method according to another aspect of the invention also has a step of: generating and sending a dummy response in response to the command to the program when the command sent is determined to request the status of the external device.

In a control device control method according to another aspect of the invention, when it is determined that the specified command was received after a command telling the external device to enter the power conservation state was sent to the external device, a command causing the external device to resume normal operation from the power conservation state is generated and sent to the external device through the interface.

With the method according to this aspect of the invention, when a specific command related to the external device is sent to the response control unit by the operation of a program executed by the control device, the response control unit sends the command to the generic device driver and the external device operates as controlled by the generic device driver. When a command other than the specific command is sent, the response control unit instead of the generic device driver sends a dummy response to the program and the generic device driver does not operate. If the time for which the specific command is not sent continues for a specified time or longer, a function of the power management module shifts the external device to a power conservation state.

As a result, the external device can be operated without affecting operation of the program when controlling the external device only by the generic device driver is necessary, and the generic device driver and external device can be operated more efficiently without relying on a function of the generic device driver. In addition, the external device can be moved to a power conservation state to reduce power consumption and improve operating efficiency of the external device when the generic device driver and external device are not operated for a certain period of time. The generic device driver can therefore be used to control the external device, and power conservation and operating efficiency can be improved without relying on a function of the generic device driver.

Another aspect of the invention is a recording medium that stores a program executed by a control device that can connect through an interface to an external device, the program including steps of: the program receiving and determining if a command generated and sent by a host program installed on the control device is a specific command; and if the time for which the response control unit does not receive the specific command is greater than or equal to a specified time, generating a command that causes the external device to enter a power conservation state, and sending the command through the interface to the external device.

Preferably, the program sends the command to the device driver when the command sent by the host program is determined to be a specific command, and does not send the command to the device driver when the command is determined to be other than the specific command.

In the program according to another aspect of the invention, the device driver is preferably a generic device driver that can control plural types of external devices.

In the program according to another aspect of the invention, the specified command includes a recording job instructing the external device to execute a recording operation, and commands other than the specified command include a command requesting a status report from the external device.

The program according to another aspect of the invention preferably also has a step of: generating and sending a dummy response in response to the command to the host program when the command sent is determined to request the status of the external device.

When a specific command related to the external device is sent to the response control unit by the operation of a host program, which may be an application program or a control program that controls the external device, installed on and executed by a control device connected to the external device, the response control unit sends the command to the generic device driver and the external device operates as controlled by the generic device driver. When a command other than the specific command is sent, the response control unit instead of the generic device driver sends a dummy response to the host program and the generic device driver does not operate. If the time for which the specific command is not sent continues for a specified time or longer, a function of the power management module shifts the external device to a power conservation state.

As a result, the external device can be operated without affecting operation of the program when controlling the external device only by the generic device driver is necessary, and the generic device driver and external device can be operated more efficiently without relying on a function of the generic device driver. In addition, the external device can be moved to a power conservation state to reduce power consumption and improve operating efficiency of the external device when the generic device driver and external device are not operated for a certain period of time. The generic device driver can therefore be used to control the external device, and power conservation and operating efficiency can be improved without relying on a function of the generic device driver.

### Effect of at Least One of Embodiment of the Invention

At least one of embodiment of the invention enables using a generic device driver to control an external device while improving power conservation and operating efficiency without relying on a function of the generic device driver.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a function block diagram showing the configuration of a printing system according to a preferred embodiment of the invention.

FIG. 2 schematically describes the functional configuration of the host computer.

FIG. 3 is a flow chart describing the operation of the host computer.

FIG. 4 is a flow chart describing the operation of the printer.

### DESCRIPTION OF EMBODIMENTS

A preferred embodiment of the present invention is described below with reference to the accompanying figures.

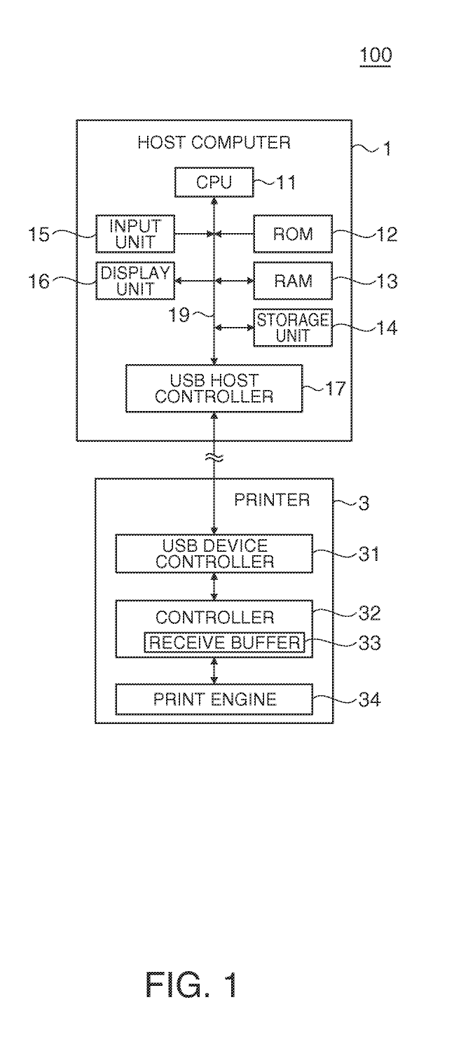

FIG. 1 is a block diagram showing the configuration of a printing system 100 (control system) according to a preferred embodiment of the invention.

As shown in the figure, the printing system 100 includes a host computer 1 (control device) and a printer 3 (external device) communicably connected to the host computer 1. The host computer 1 in this embodiment of the invention is, for example, a POS terminal device that is installed at a checkout counter in a retail store as part of a POS system that runs a POS application to register product sales and process sale transactions, and prints (records) a receipt by the printer 3 for every transaction. The host computer 1 therefore also has a barcode scanner for reading product barcodes when processing a sale, and a cash drawer that stores money used to process payments, but these and other parts are not shown in the figures for brevity. The printing system 100 corresponds to a control system according to an embodiment of the invention, the host computer 1 corresponds to a control device, and the printer 3 corresponds to a recording device as an example of an external device that is controlled by the control device according to the invention.

The host computer 1 has a CPU 11 that executes programs; ROM 12 that stores the basic control program executed by the CPU 11; RAM 13 used as working memory to temporarily store the program executed by the CPU 11 and process data; a storage unit 14 that stores application programs executed by the CPU 11 and process data; an input unit 15 having a total key and other keys operated by the operator; a display unit 16 that displays content during the product sale and transaction processes, for example; a USB host controller 17 that is connected by wire to the printer 3 and controls communication with the printer 3; and a bus 19 through which these various parts are connected to each other. The USB host controller 17 functions as a USB interface that enables connecting the printer 3 and other devices through a USB connector.

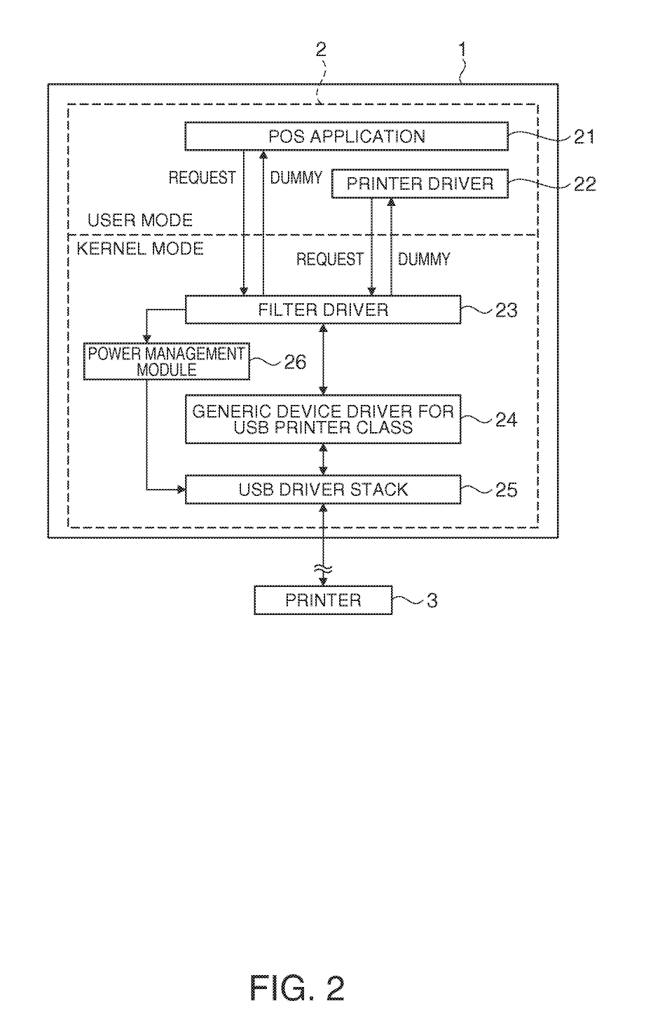

Stored in the storage unit 14 as programs executed by the CPU 11 are the operating system 2 (FIG. 2) of the host computer 1, a POS application 21 (application program, FIG. 2) as an application program for executing a sale registration process and transaction process as a POS system; a printer driver 22 (control program, FIG. 2) as a control program that generates print jobs sent to the printer 3 in response to requests from the POS application 21; and a registry that stores settings related to the operation of the operating system 2.

The printer 3 outputs a receipt with each transaction as controlled by the host computer 1. The printer 3 is, for example, a thermal line printer that prints (records) text and images in monochrome or color by applying heat by a line thermal head having a heating element to the recording surface of thermal roll paper, which is thermo-sensitive paper wound into a roll, while conveying the thermal roll paper by a roller platen.

The printer 3 includes a USB device controller 31 connected by wire to the host computer 1; a controller 32 that controls the parts of the printer 3 according to commands received from the host computer 1 through the USB device controller 31; a receive buffer 33 that temporarily stores commands and data received from the host computer 1; and a print engine 34 that prints on the thermal roll paper by the line thermal head, platen, and other parts of the printer 3.

FIG. 2 schematically describes the functional configuration of the host computer 1. The functional units shown in FIG. 2 are rendered by the cooperation of hardware and software as a result of the CPU 11 executing a program and controlling the USB host controller 17.

As shown in FIG. 2, the host computer 1 has a USB driver stack 25 that controls the USB host controller 17 (FIG. 1) in the kernel mode of the operating system 2, and a generic device driver 24 that controls the printer 3 using the USB driver stack 25.

The POS application 21 and the printer driver 22, which produces print jobs for the printer 3 in response to print requests from the POS application 21, are executed in the user mode of the operating system 2. The printer driver 22 is a program that is invoked by the POS application 21 or is independently executed, and has functions for generating the print jobs that are executed by the printer 3, and managing the operating status of the printer 3.

The POS application 21 and printer driver 22 have functions for sending status requests to the program controlling the printer 3 in the kernel mode of the operating system 2 to request transmission of the printer 3 status, and receiving responses to these status requests.

The printer driver 22 generates print data for printing text and images according to the document data including text and images generated by the POS application 21, generates control commands for printing the resulting print data on the printer 3, and generates print jobs containing these control commands and print data.

The generic device driver 24 is a device driver that can be shared by plural different types of printers connected through the USB host controller 17, which is a USB interface. When the operating system 2 is the Microsoft Windows (R) operating system, the generic device driver 24 is installed to the Windows (R) operating system as a device driver for the USB printer class, which is compatible with a wide range of printers.

When a print job is input from the POS application 21, the generic device driver 24 calls the USB driver stack 25 to execute the print job and controls communication with the printer 3.

Communication with the printer 3 by the generic device driver 24 uses a polling method in which the generic device driver 24 is the host device and the printer 3 is the target device. More specifically, the generic device driver 24 sends a clear command to the printer 3 using a function of the USB driver stack 25, and the printer 3 that receives the clear command clears the counter that counts how much data has been received and then returns a response to the host computer 1. After receiving a response from the printer 3, the generic device driver 24 sends the print job data including the control commands and print data in packets of a certain size to the printer 3, and receives an acknowledge response from the printer 3 each time a specific number of packets is sent. The generic device driver 24 waits until the acknowledge response and printing completed response are received from the printer 3.

The host computer 1 has a filter driver 23 (response control unit) that filters and relays requests from the POS application 21 and printer driver 22 to the generic device driver 24 in the kernel mode of the operating system 2.

The filter driver 23 resides between the POS application 21 and printer driver 22 and the generic device driver 24, and relays commands sent by the POS application 21 or printer driver 22 to the generic device driver 24. The filter driver 23 also has a filtering function, and does not relay commands other than print jobs to the generic device driver 24. More specifically, when a print job is sent from the POS application 21 or printer driver 22, the filter driver 23 outputs the print job to the generic device driver 24. However, when a status request is output by the POS application 21 or printer driver 22, the filter driver 23 generates a dummy status report in response to the status request, sends the dummy report to the POS application 21 or printer driver 22 that issued the status request, and does not pass the status request to the generic device driver 24. The generic device driver 24, USB driver stack 25, and printer 3 therefore do not operate in response to the status request.

In addition to status requests, the filter driver 23 does not pass other non-print job commands to the generic device driver 24, and returns a dummy response on behalf of the generic device driver 24 to other commands requesting a response. As a result, of the commands sent from the POS application 21 and printer driver 22, the generic device driver 24, USB driver stack 25, and printer 3 execute only print jobs and do not receive other commands.

The host computer 1 also has a power management module 26 that operates in the kernel mode of the operating system 2. The power management module 26 outputs commands telling the printer 3 to enter a sleep mode (a power-saving state) and to wake up (resume) from the sleep mode as controlled by the filter driver 23. More specifically, the power management module 26 calls the USB driver stack 25 as needed and sends the foregoing commands to the printer 3 using a function of the USB driver stack 25.

The sleep mode is a state in which the printer 3 power is on, the USB device controller 31 can communicate with the host computer 1, and the controller 32 has stopped operating. This sleep mode is sometimes called a suspend, standby, or pause mode, for example, but is referred to herein as a sleep mode. In contrast to the sleep mode, the normal operating state in which the USB device controller 31 operates normally is called the “normal operating mode.”

In the sleep mode, the printer 3 receives and sequentially stores commands and data sent from the host computer 1 through the USB device controller 31 to the receive buffer 33, but does not execute the received commands. The received commands therefore accumulate in the receive buffer 33 in the order received. However, if the received command is a real-time control command, the USB device controller 31 detects the real-time control command, and causes the printer 3 to wake from the sleep mode, resume the normal operating mode, and execute the real-time control command by the USB device controller 31. Real-time control commands require immediate execution regardless of whether the device is in the sleep mode or normal operating mode, and include, for example, commands to return from the sleep mode to the normal operating mode, receive buffer 33 clear commands, printer 3 initialization commands, status report commands, and cash drawer opening commands.

When, for example, the receive buffer 33 becomes full or a cover is opened to load or remove thermal roll paper, the printer 3 goes off-line and stops executing the print job in progress, for example, but real-time control commands are executed when the USB device controller 31 receives a real-time control command even in the off-line mode.

Commands sent by the power management module 26 to the printer 3 to go to the sleep mode, and commands for resuming the normal operating mode from the sleep mode, are real-time control commands. As a result, the printer 3 responds immediately to commands sent from the power management module 26, and a response is returned from the printer 3 to the host computer 1. The power management module 26 can receive the response through the USB driver stack 25 and generic device driver 24.

The filter driver 23 has a timer for counting the passage of time. More specifically, this timer counts how much time has passed since the last time a command was sent to the generic device driver 24. If the timer count exceeds a previously set threshold time, the filter driver 23 controls the power management module 26 to set the printer 3 to the sleep mode.

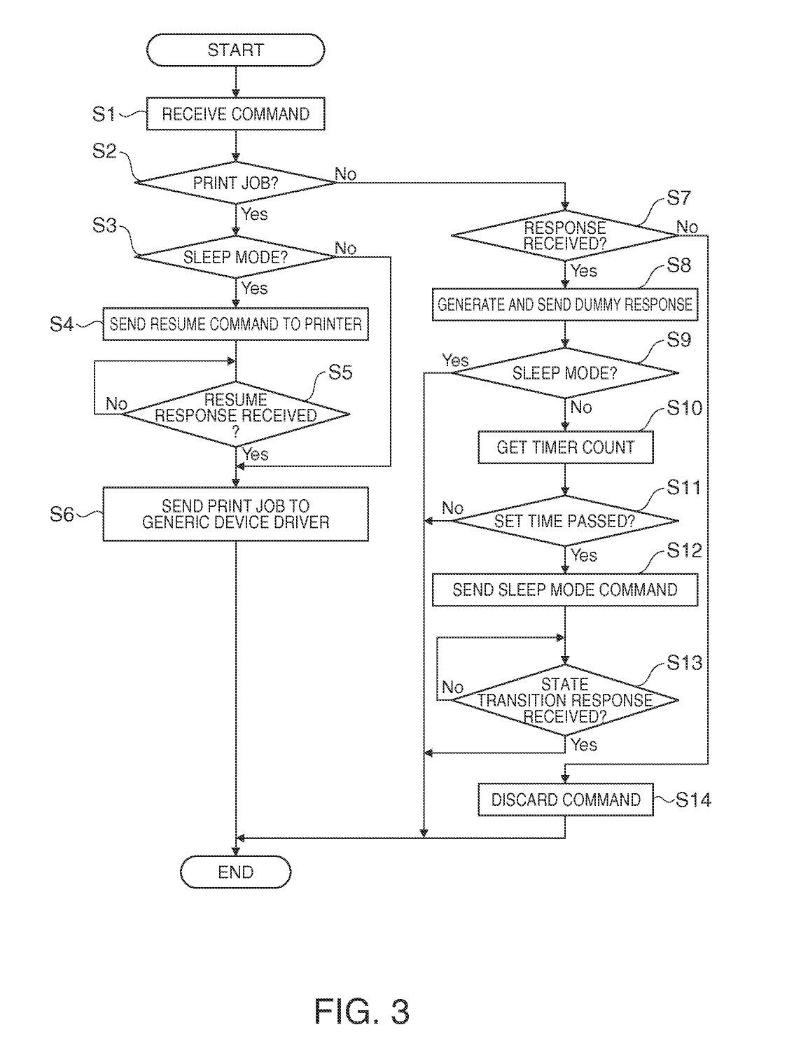

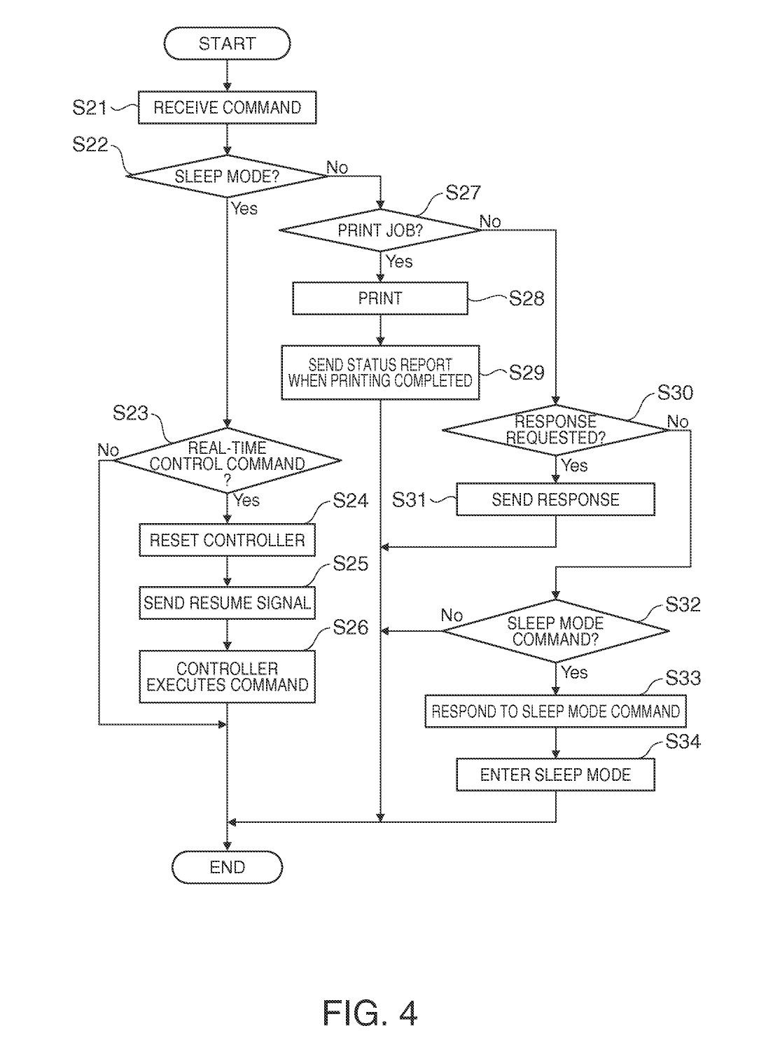

FIG. 3 and FIG. 4 are flow charts showing the operation of the printing system 100. FIG. 3 describes the operation of the host computer 1, and more specifically describes operations based on the function of the filter driver 23.

In the operation described in FIG. 3, the filter driver 23 of the host computer 1 is executed every time a command sent from the POS application 21 or printer driver 22 is received. Each time a command is received (step S1), the filter driver 23 determines if the received command is a print job (step S2).

If the received command is determined to be a print job (step S2 returns Yes), the filter driver 23 determines if the printer 3 is in the sleep mode (step S3). If the printer 3 is in the sleep mode (step S3 returns Yes), a function of the power management module 26 sends a command to wake from the sleep mode to the printer 3 (step S4), and waits for a response from the printer 3 that operation resumed from the sleep mode (step S5). When a resume response signal indicating recovery from the sleep mode is received from the printer 3 (step S5 returns Yes), the filter driver 23 sends the print job sent from the POS application 21 or the printer driver 22 to the generic device driver 24 (step S6), and ends this process. When the print job is executed by the printer 3, and a status report indicating that the print job was completed is received from the printer 3 after execution is completed, the filter driver 23 passes this status report to the printer driver 22 or filter driver 23 that sent the print job.

If the printer 3 is not in the sleep mode (step S3 returns No), the filter driver 23 goes to step ST6 and passes the print job to the generic device driver 24.

If the command sent from the POS application 21 or printer driver 22 is not a print job (step S2 returns No), the filter driver 23 determines if the received command is a command, such as a status request, that requires a response (step S7). If the command requires a response (step S7 returns Yes), the filter driver 23 generates and sends a dummy response to the POS application 21 or printer driver 22 that sent the command (step S8).

Next, the filter driver 23 determines if the printer 3 is in the sleep mode (step S9). If the printer 3 is not in the sleep mode (step S9 returns No), the filter driver 23 acquires the timer count (step S10), and determines if this count exceeds a previously set value (predetermined time) (step S11). If the timer count exceeds the preset time (step S11 returns Yes), the filter driver 23 controls the power management module 26 to send a command to enter the sleep mode to the printer 3 (step S12), and then waits for a response from the printer 3 to this command (step S13).

When a response (status report) indicating transition to the sleep mode is received from the printer 3 (step S13 returns Yes), the filter driver 23 ends this process. This process also ends if the printer 3 is not in the sleep mode (step S9 returns Yes), and the timer count does not exceed the preset time (step S11 returns No).

In addition, if the command received from the POS application 21 or printer driver 22 is not a print job or a command a requesting a response (step S7 returns No), the received command is discarded (step 514) and this process ends.

FIG. 4 is a flow chart describing the operation of the printer 3 when a command is received from the generic device driver 24 through the USB driver stack 25 as controlled by the filter driver 23.

When the printer 3 receives a command sent from the host computer 1 by a function of the USB device controller 31 (step S21), the printer 3 determines if the printer 3 is in the sleep mode (step S22).

If the printer 3 is in the sleep mode (step S22 returns Yes), the USB device controller 31 determines if the received command is a real-time control command (step S23). If the received command is a real-time control command, the USB device controller 31 starts the controller 32 from the stopped state and awakes from the sleep mode (step S24). The controller 32 controls the USB device controller 31 to send a resume response signal to the host computer 1 (step S25), execute the real-time control command by the controller 32 (step S26), and end this process. If the command received in the sleep mode is not a real-time control command (step S23 returns No), the USB device controller 31 stores the received command in the receive buffer 33 and ends this process.

If the printer 3 is not in the sleep mode (step S22 returns No), that is, if the printer 3 is in the normal operating mode, the USB device controller 31 or controller 32 of the printer 3 determines if the received command is a print job (step S27). If it is a print job (step S27 returns Yes), the controller 32 executes the print job and prints on the thermal roll paper (step S28). The controller 32 then generates and sends a status report indicating that printing ended to the host computer 1 by a function of the USB device controller 31 (step S29), and ends this process.

If the printer 3 is in the normal operating mode and the received command is not a print job (step S27 returns No), the USB device controller 31 or controller 32 of the printer 3 determines if the received command is a command requiring a response (step S30). If the command requires a response (step S30 returns Yes), the controller 32 generates the response to the command and sends the response to the host computer 1 by a function of the USB device controller 31 (step S31), and ends this process.

If the printer 3 is in the normal operating mode and the received command is not a command requiring a response (step S30 returns No), the USB device controller 31 or controller 32 of the printer 3 determines if the received command is a command instructing going to the sleep mode (step S32).

If the received command is not a command to enter the sleep mode (step S32 returns No), the USB device controller 31 of the printer 3 discards the command and ends this process.

If the received command is a command for entering the sleep mode (step S32 returns Yes), the controller 32 generates a status report indicating transition to the sleep mode, sends the status report to the host computer 1 by a function of the USB device controller 31 (step S33), then enters the sleep mode (step S34), and ends this process.

The printer 3 also immediately goes to the off-line state whenever a cause of going off-line occurs, such as when a cover is opened to load or unload the thermal roll paper, the thermal roll paper runs out while printing, or the receive buffer 33 becomes full. Going to the off-line state is an interrupt process triggered by occurrence of an off-line cause, and may occur at any time while the printer 3 is executing the operation shown in FIG. 4 or while paused (in standby mode).

The printer 3 also has other operating switches such as a power switch for turning the printer 3 power on and off, a printer 3 reset switch, and a thermal roll paper feed switch, and performs operation corresponding to the operation of the power switch and other operating switches. These operations are also interrupt processes triggered by operating the power switch or other operating switch.

When an interrupt process is executed in the sleep mode, the printer 3 resumes the normal operating mode from the sleep mode. In this case the printer 3 sends a status report indicating resuming the normal operating mode to the host computer 1. As a result, the printer driver 22, filter driver 23, and generic device driver 24 of the host computer 1 can detect that the printer 3 returned to the normal operating mode. For example, after the printer 3 goes to the sleep mode, the host computer 1 can set the USB host controller 17 to a sleep mode. In this case, the USB host controller 17 can be returned to the normal operating mode by the generic device driver 24, and can be returned to the normal operating mode by a status report from the printer 3. As a result, the printer 3 can be set to the sleep mode by sending a command from the host computer 1 to the printer 3, and the printer 3 can be easily reset to the normal operating mode as necessary to resume normal processing.

As described above, a printing system 100 according to a preferred embodiment of the invention has a USB host controller 17 as an interface for connecting an external device. The host computer 1 connected through the USB host controller 17 to the printer 3 being controlled has a generic device driver 24 that can control plural different types of printers 3 connected through the USB host controller 17 according to commands sent by a POS application 21 as an example of a host program or by operation of a printer driver 22 that controls the printer 3; a power management module 26 that can set a device connected through the USB host controller 17 to a sleep mode; and a filter driver 23 that can selectively relay to the generic device driver 24 commands that are sent based on the operation of the host program.

If the command that is sent based on the operation of the host program is a print job, the filter driver 23 relays the print job to the generic device driver 24. If the received command is not a print job, the filter driver 23 returns a dummy response to the command to the host program without relaying the command to the generic device driver 24. If the time during which a print job is not received is greater than or equal to a previously set threshold time, the printer 3 is set to the sleep mode by a function of the power management module 26.

As a result, the generic device driver 24 can be used to control the printer 3 when executing a print job without affecting the operation of the POS application 21 and printer driver 22, and when a print job is not executed, a function of the filter driver 23 and power management module 26 can set the printer 3 to a sleep mode, and operation of the generic device driver 24 and printer 3 can be made more efficient. The generic device driver 24 can therefore be used effectively to control the printer 3, and power conservation and operating efficiency can be improved without depending on a function of the generic device driver 24.

The power management module 26 of the host computer 1 sends a command telling the printer 3 to enter the sleep mode to the printer 3 as controlled by the filter driver 23. As a result, insofar as the printer 3 is a model that can respond to a command for entering the sleep mode, the printer 3 can simply go to the sleep mode or execute the print job based on the received command, and does not need to execute a special operation. As a result, a configuration that can improve power conservation and more efficient operation without relying on a function of a generic device driver 24 can be easily rendered.

If the filter driver 23 receives a print job after the printer 3 is set to the sleep mode, a function of the power management module 26 sends a real-time control command that wakes the printer 3 from the sleep mode, resets the printer 3 from the sleep mode to the normal operating mode, and sends the print job. Because the normal operating mode can be resumed as needed after the printer 3 goes to the sleep mode, the printer 3 sleep mode can be used without affecting operation of a host program, and power conservation and operating efficiency can be improved.

The filter driver 23 operates in the kernel mode of the operating system 2. As a result, compared with operating in a user mode, the filter driver 23 is less dependent on the operating system 2 and the specifications of the printer 3, the filter driver 23 can be easily adapted to an operating system 2 other than a POS system, and the filter driver 23 can be used with other types of printers than the foregoing printer 3.

It will be obvious to one with ordinary skill in the related art that the foregoing embodiment is only one example of the invention, which is not limited thereto. For example, the foregoing embodiment describes a configuration having a power management module 26 separately to the filter driver 23, but the invention is not so limited. For example, the filter driver 23 may be rendered with the functions of the power management module 26. In addition, the power management module 26 may be rendered as part of the USB driver stack 25, and the power management module 26 may be rendered as a module that operates in the user mode of the operating system 2. In addition, the host computer 1 and printer 3 are described above as being connected through a USB interface, but the invention is not so limited. For example, the printer 3 may use any wired or wireless communication interface other than the USB interface that enables changing to a sleep mode or other power conservation mode, and resuming normal operation from this mode.

The preferred embodiment of the invention described above describes a configuration in which a thermal printer that prints on thermal roll paper by a line thermal head having a heating element is used as an external device, but the external device of the invention is not limited thereto and may be any type of printer that can print previously stored image data, including dot impact printers, inkjet printers, and laser printers. The invention can also be applied to printers that are incorporated in other types of devices.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A control device that can connect through an interface to an external device, comprising:
a device driver that controls the external device based on a command generated by a program installed on the control device;
a power management module that generates a command that causes the external device to enter a power conservation state; and
a response control unit that relays communications between the program and the device driver, and selectively sends commands received from the program to the device driver;
the response control unit determining if a command sent by the program is a specific command, and
the power management module generating and sending through the interface to the external device a command to move the external device to the power conservation state when the response control unit does not receive the specific command for a specified time or longer.

2. The control device described in claim 1, wherein:
the command causing the external device to enter the power conservation state is a command setting the external device to a sleep mode.

3. The control device described in claim 1, wherein:
the device driver is a generic device driver that can control plural types of external devices.

4. The control device described in claim 1, wherein:
the response control unit sends the command to the device driver when the command sent by the program is determined to be a specific command, and does not send the command to the device driver when the command is determined to be other than the specific command.

5. The control device described in claim 4, wherein:
the specified command includes a recording job instructing the external device to execute a recording operation, and commands other than the specified command include a command requesting a status report from the external device.

6. The control device described in claim 5, wherein:
the response control unit generates and sends a dummy response in response to the command to the program when the command sent by the program is determined to request the status of the external device.

7. The control device described in claim 1, wherein:
the power management module sends to the external device a command telling the external device to enter a power conservation state as controlled by the response control unit.

8. The control device described in claim 1, wherein:
when the response control unit determines that the specified command was received after sending to the external device a command telling the external device to enter the power conservation state, the response control unit generates by the power management module a command causing the external device to resume normal operation from the power conservation state, and sends the command to the external device through the interface.

9. A control method for a control device that can connect through an interface to an external device, comprising steps of:
receiving and determining if a command generated and sent by a program installed on the control device is a specific command; and
if the time for which the response control unit does not receive the specific command is greater than or equal to a specified time,
generating a command that causes the external device to enter a power conservation state, and
sending the command through the interface to the external device.

10. The control device control method described in claim 9, wherein:
the command causing the external device to enter the power conservation state is a command setting the external device to a sleep mode.

11. The control device control method described in claim 9, wherein:
the command is sent to the device driver when the command sent by the program is determined to be a specific command, and the command is not sent to the device driver when the command is determined to be other than the specific command.

12. The control device control method described in claim 11, wherein:
the device driver is a generic device driver that can control plural types of external devices.

13. The control device control method described in claim 11, wherein:
the specified command includes a recording job instructing the external device to execute a recording operation, and commands other than the specified command include a command requesting a status report from the external device.

14. The control device control method described in claim 13, further comprising a step of:
generating and sending a dummy response in response to the command to the program when the command sent is determined to request the status of the external device.

15. The control device control method described in claim 9, wherein:
when it is determined that the specified command was received after a command telling the external device to enter the power conservation state was sent to the external device, a command causing the external device to resume normal operation from the power conservation state is generated and sent to the external device through the interface.

16. A recording medium that stores a program executed by a control device that can connect through an interface to an external device, the program comprising steps of:
receiving and determining if a command generated and sent by a host program installed on the control device is a specific command; and
if the time for which the response control unit does not receive the specific command is greater than or equal to a specified time,
generating a command that causes the external device to enter a power conservation state, and
sending the command through the interface to the external device.

17. The recording medium storing the program described in claim 16, wherein:
the command is sent to the device driver when the command sent by the host program is determined to be a specific command, and the command is not sent to the device driver when the command is determined to be other than the specific command.

18. The recording medium storing the program described in claim 17, wherein:
the device driver is a generic device driver that can control plural types of external devices.

19. The recording medium storing the program described in claim 17, wherein:
the specified command includes a recording job instructing the external device to execute a recording operation, and commands other than the specified command include a command requesting a status report from the external device.

20. The recording medium storing the program described in claim 19, further comprising a step of:
generating and sending a dummy response in response to the command to the host program when the command sent is determined to request the status of the external device.
